(19) United States
(12) Patent Application Publication
(10) Pub. No.: US 2025/0129801 A1
(43) Pub. Date: Apr. 24, 2025

(54) Hydraulic Accumulator

(71) Applicant: Hydac Technology GmbH, Sulzbach / Saar (DE)

(72) Inventors: Peter Kloft, Ransbach-Baumbach (DE); Torsten Kusserow, Thörnich (DE); Jens Holger Köhne, Saarbrücken (DE)

(73) Assignee: Hydac Technology GmbH, Sulzbach / Saar (DE)

(21) Appl. No.: 18/724,044

(22) PCT Filed: Dec. 7, 2022
(86) PCT No.: PCT/EP2022/084785

§ 371 Date: Jun. 25, 2024

(30) Foreign Application Priority Data
Dec. 28, 2021 (DE) 10 2021 006 456.9

(51) Int. Cl. F15B 1/08; F15B 1/10; F15B 1/24

(52) U.S. Cl. CPC F15B 1/083; F15B 1/103; F15B 1/24; F15B 2201/205; F15B 2201/3153

(57) ABSTRACT

The disclosure relates to a hydraulic accumulator comprising an accumulator housing and a separating element which is arranged therein in a longitudinally movable manner and which separates two media chambers within the accumulator housing, in particular a chamber with a working gas, such as nitrogen gas, from another chamber with a liquid, such as hydraulic oil, and a bursting device for reducing an inadmissibly high pressure in the accumulator housing, wherein the bursting device is arranged in the separating element, and when the bursting device bursts, a media-conducting connection between the two media chambers is released via the separating element.

### CROSS-REFERENCE TO RELATED APPLICATIONS

This application claims priority to German Patent Application No. DE 10 2021 006 456.9, filed on Dec. 28, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a hydraulic accumulator comprising an accumulator housing and a separating element which is arranged therein in a longitudinally movable manner and which separates two media chambers within the accumulator housing, in particular a chamber with a working gas, such as nitrogen gas, from another chamber with a liquid, such as hydraulic oil, and a bursting device for reducing an inadmissibly high pressure in the accumulator housing.

To guarantee safety when operating devices with containers containing a compressed gas, such as hydraulic accumulators, amongst other things, all hazards that might arise on the installation site must also be taken into consideration, wherein potentially damaging external influences are also significant, particularly temperature increases that arise in the event of a fire in the immediate environment of such containers, which are subject to gas pressure, and which might lead to failure of the container.

DE 10 2010 011 879 A1 proposes a safety device for containers subject to gas pressure, in particular for protecting the gas side of the working chamber of hydropneumatic devices, such as hydraulic accumulators.

### SUMMARY

A need exists to provide an improved hydraulic accumulator. The need is addressed by the subject matter according to the independent claim(s). Embodiments of the invention are described in the dependent claims, the following description, and the drawings.

### BRIEF DESCRIPTION OF THE DRAWINGS

FIG. 1 shows an example longitudinal section through a bellows accumulator in its entirety;

FIG. 2 shows an example enlarged view of the bottom region of the bellows accumulator according to FIG. 1;

FIG. 3 shows an example longitudinal section through a piston accumulator according to a further embodiment; and

FIG. 4 shows an example enlarged view of a separating element in the form of a separating piston as shown in FIG. 3.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments it is provided that the bursting device is arranged in the separating element and, when it bursts, releases a media-conducting connection between the two media chambers via the separating element. Compared with the known solutions, this always prevents parts of the bursting device being inadvertently dispersed into the surrounding area in the event of failure, with the result that people or machine parts located in the vicinity of the hydraulic accumulator failing in this manner are not endangered. The working gas on the gas side of the hydraulic accumulator is generally also under an extremely high precharge pressure, with the result that relieving into the surrounding area may also be associated with safety risks, which are avoided with the solution according to the embodiments.

In some embodiments, the bursting device is located in the separating element inside the hydraulic accumulator. Thus, under no circumstances do parts of the corresponding bursting device pass into the surrounding area in the event of failure but instead remain inside the accumulator housing of the hydraulic accumulator, which is generally designed as a high-pressure component and has received safety approval. As such, in the event of failure, the working or compressed gas is also relieved on to the liquid side of the accumulator and, due to the considerable damping effect of the liquid, this ensures extensive relief of the pressure accumulator housing. It is also possible to accommodate such hydraulic accumulators with the bursting device in the separating element between the two media chambers of the hydraulic accumulator in a defined manner in an approved failure zone as part of operation of entire hydraulic systems such that, in the event of failure, the associated hydraulic circuit along with connected hydraulic devices need not be detrimentally affected. In this manner, reducing an inadmissible rise in pressure can be relocated to less critical areas by means of corresponding safety devices in predefined areas of the hydraulic system. Even though the hydraulic accumulator is intended to be exposed to a large number of load cycles with a corresponding pressure fluctuation range and extremely high gas temperatures, which may arise accordingly during dynamic operation of the hydraulic accumulator, said hydraulic accumulator is also designed as a sealed system in the event of failure such as to rule out any safety risk to the environment.

In some embodiments, it is provided that the bursting device is formed by a bursting plug which is inserted into a through opening in the separating element. As such, the bursting device can be implemented in a central location in the separating element in a particularly cost-effective manner.

In this case, it is for example provided that the plug-like bursting device comprises an engagement part, which is inserted into the through opening, in particular screwed into the separating element via a threaded section along the through opening. As such, a secure releasable attachment of the bursting device in the separating element is achieved, which is for example also assisted by the fact that the bursting device comprises an abutting part, with a diameter that is larger than the diameter of the engagement part, the abutting part being in surface contact with the separating element in a supporting manner, with the result that a surface force application is obtained via the abutting part into the separating element.

It is also beneficial from a production engineering perspective if the engagement and abutting part are each integral components of the bursting device.

In some embodiments, it is provided that at least one longitudinal channel runs in the engagement part, one end of said channel emerging in the second media chamber with the liquid and the other end of said channel emerging in the abutting part such that a kind of membrane arises on the top side of the abutting part, said membrane being adjacent to the first media chamber with the working gas. Thanks to the membrane, the thickness of which can be predefined accordingly, a kind of defined breaking point is formed, which, when it fails, enables the working gas to be discharged in a defined manner at high pressure via the longitudinal channel in the engagement part in the direction of the liquid chamber of the hydraulic accumulator.

To prevent the media received in the media chambers, particularly working gas and liquid, inadvertently coming into contact with each other during normal operation, a sealing device is arranged between the bursting device and the separating element.

For example, the hydraulic accumulator can be designed as a bellows accumulator; but also as a piston accumulator, in which case the separating element is formed by a bellows or by a separating piston respectively.

In any event, this ensures that, in the event of the bursting device failing, all fragments of said bursting device remain sealed from the outside inside the accumulator housing and an associated inadmissibly high gas pressure on the liquid side of the accumulator is relieved, and, as such, the working gas is also unable to inadvertently escape into the surrounding area. This therefore has no parallel in the prior art.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

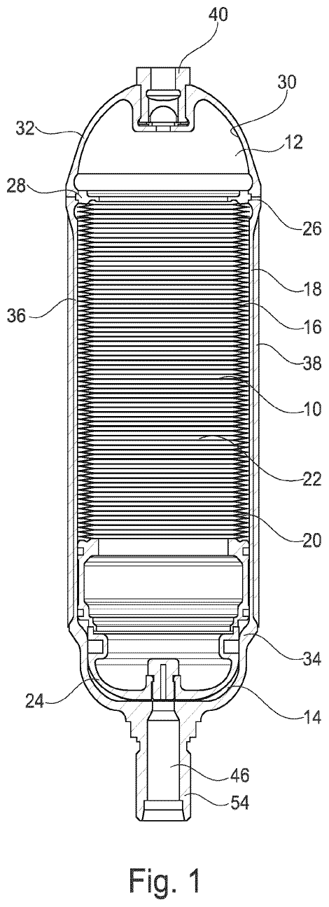

The bellows accumulator shown in FIG. 1 is a special form of hydraulic accumulator, in which a bellows 16 acting as a movable separating element 10 between a first media chamber 12, in particular in the form of a gas side, and a second media chamber 14, in particular in the form of a liquid side, comprises, on its bellows end 20 that can be moved in the axial direction when expanding and contracting in an accumulator housing 18, a sealing body 24 sealing the inner chamber 22 of the bellows 16 in a media-tight manner, said sealing body being guided such that it can be moved longitudinally in the accumulator housing 18 in this manner. At its other bellows end 26, the bellows 16 is fixed immovably in the accumulator housing in relation to said accumulator housing 18. A fixing ring 28 is used for this purpose, said ring being welded in the conventional manner to the end of the bellows 16 and to the inside 30 of the accumulator housing 18. The accumulator housing 18 as such consists of three individual interconnected or welded, respectively, housing parts, the upper housing part 32 and the lower housing part 34 being designed to be dome-shaped, and a cylindrical housing part 36 arranged therebetween can be provided with a fibre winding 38 on its outer conference in the conventional manner to stabilise pressure.

A compressible medium is introduced into the first media chamber 12, for example in the form of a working gas, such as nitrogen gas, which is subjected to a predefinable preload or precharge pressure. A metal part 40 with a glass insert in the form of a sight glass allows events inside the hydraulic accumulator to be assessed from outside. The hydraulic accumulator can be filled with working gas, such as nitrogen gas, via a sealing part in the upper housing part 32, said sealing part not being shown in further detail. Furthermore, the bellows 16 is shown in its possible maximum expanded position in FIG. 1 and during contraction of the bellows 16, the associated displacement movement thereof is limited by the individual pleats of the bellows 16, which then lie on top of one another, i.e. together form a block. For example, the bellows 16 is manufactured from a stainless steel material which is media-resistant and stable under pressure and ensures that the working gas admitted in the media chamber 12 under the preload pressure is unable to pass into the second media chamber 14 with the liquid, such as hydraulic oil, during normal operation. Corresponding bellows accumulators are generally connected on their liquid side to hydraulic supply circuits (not shown).

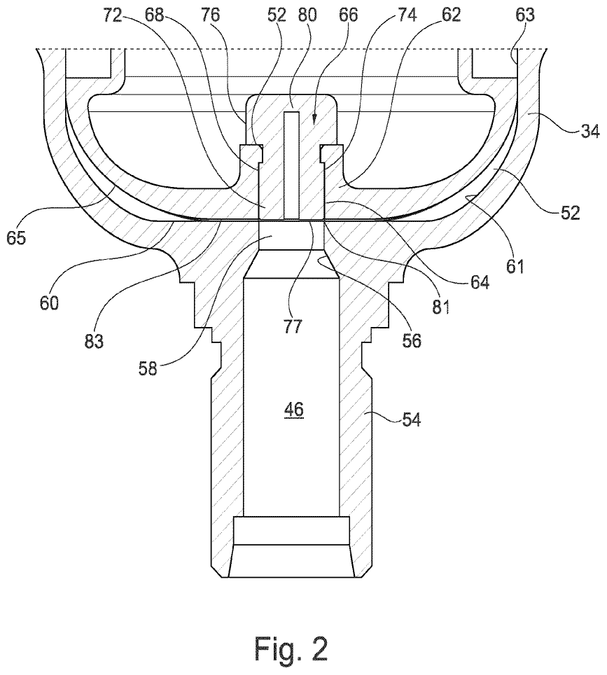

As is also shown on FIGS. 1 and 2, the sealing body 24 is designed as a kind of hemispherical shell, which, when the bellows 16 is in its possible fully expanded state, delimits a small defined chamber volume 52 to receive liquid on the liquid side 46 of the hydraulic accumulator. The liquid side 46 comprises a hollow-cylindrical connecting part 54, which is for example equipped with a male thread in the conventional manner to attach the hydraulic accumulator to a third component, such as an accumulator block (not shown). The connecting part 54 engages around a cylindrical fluid passage, which, viewed in the direction of the dome-shaped sealing body 24, is reduced in diameter by means of a step 56 tapering conically towards the sealing body 24 forming a connection point 58. The connection point 58 is surrounded by a flat annular surface 60, which, as shown in FIG. 2, runs in a horizontal plane, viewed transverse to the longitudinal axis of the hydraulic accumulator. Adjacent thereto, the further inner circumferential side 61 of the lower housing part 34 runs along a convex curve, viewed from the inside of the hydraulic accumulator, up to a wall piece 63 as a transition point running cylindrically and coaxially in relation to the longitudinal axis of the hydraulic accumulator. The corresponding curvature is less curved than the assignable convex curvature on the outside 65 of the sealing body 24. As such, a free chamber volume 52 arises when viewed in cross-section, said volume being designed in the form of a shell tapering to a point at its free ends and for instance comprising the largest free cross-section in the lower third when viewed in the direction of FIG. 2. Overall, a curved lens shape arises in this manner for the chamber volume 52 that is filled with liquid during operation of the accumulator.

Viewed concentrically in relation to the longitudinal axis of the accumulator housing 18, the sealing body 24 for the first media chamber 12, viewed as shown on FIGS. 1 and 2, comprises a hollow-cylindrical shoulder 62 towards the top, which comprises a female thread 64. A bursting device referred to in its entirety as 66 is received in the receptacle of the shoulder 62 thus formed, said bursting device serving to reduce an inadmissibly high pressure in the accumulator housing 18 on its gas side. The bursting device 66 designed in the form of a bursting plug is arranged in a through opening 68 in the separating element 10, which is formed in this manner from the sealing body 24 of the bellows 16.

The plug-like busting device 66 comprises a cylindrical engagement part 72, which is inserted into the through opening 68, and in particular screwed into the separating element 10 via a threaded section along the through opening 68. For this purpose, the outer circumference of the engagement part 72 comprises a male thread 74 exactly matching the female thread 64 of the shoulder 62.

Furthermore, the bursting device 66 comprises an abutting part 76 with a diameter that is larger than the diameter of the engagement part 72, the lower side of the abutting part 76 being in surface contact with the separating element 10, the abutting part 76 being supported on the upper side of the connecting part in the form of the cylindrical shoulder 62. The outer circumference of the abutting part 76 may be furnished with contact surfaces to allow an actuating tool such as a wrench (not shown) to engage, for example, so as to respectively insert or screw in the bursting device 66 in its entirety into the shoulder 62 in this manner.

The corresponding screw connection is detachable such that, in the event of the bursting device 66 failing, it can be replaced by a new element. As is also shown on FIGS. 1 and 2, the engagement part 72 and the abutting part 76 each form integral components of the bursting device 66 in its entirety. In this case, the lower end of the engagement part 72 protrudes with a slight overhang 77, which corresponds to the thread runout of the male thread 74, over the lower side of the sealing body 24 as the separating element 10. A longitudinal channel 78 is provided in the engagement part 72, said channel running concentrically to the longitudinal axis of the hydraulic accumulator and one free end of said channel emerging in the second media chamber 14 with the liquid and the other, opposite, end of said channel emerging in the block-like abutting part 76 such that a thin-walled membrane 80 arises on the top side of the abutting part 76, said membrane being adjacent to the first media chamber 12 with the working gas. Furthermore, a sealing device 82, which is not shown in greater detail, is arranged at the transition point between the abutting part 76 and the cylindrical shoulder 62, said sealing device ensuring a media separation between the two media chambers 12, 14 with their respective fluid contents during normal operation of the hydraulic accumulator.

However, if the preload pressure inadvertently rises on the gas side of the bellows accumulator, for example due to thermal heating, as generally arises in the event of a fire, the working gas causes the membrane 80 of the bursting device 66 to burst due to its increased pressure, in which case a media or fluid-conducting connection is then released between the two media chambers 12, 14 via the separating element 10 by means of the longitudinal channel 78 thus released. In this process, the gas is relieved onto the depressurised liquid side of the hydraulic accumulator and any fragments of the membrane 80 remain on the gas and/or liquid side of the accumulator housing 18. As such, the surrounding area is protected under all circumstances from the release of working gas and/or parts of the bursting device 66 in the event of failure.

The outer diameter of the engagement part 72 with its male thread 74 is slightly smaller than the inner diameter of the connecting point 58 in the lower housing part 34. In this manner, an annular throttle point 81 is formed by the overhang of the engagement part 72 when the bellows 16 is in the expanded state, said throttle point 81 forming part of a gap 83 which extends from the throttle point 81 up to the expanding chamber volume 52 originating from the gap 83. In this case, the gap 83 may comprise individual gap channels which extend, radiating outwards, from the notional centre of the flat sealing body 24 thus formed in this region until the plane runs out in the curved region of the sealing body 24. The gap 83 can also be designed differently, for example using spacers between the adjacent flat surfaces, facing each other, of the sealing body 24 and the inside 61 of the lower housing part 34. Due to the throttle point 81 and/or the aforementioned gap passage 83, it is possible for the liquid to flow into and out of the hydraulic accumulator with low pressure losses and low turbulence such that there is no possibility of any cavitation that might damage material.

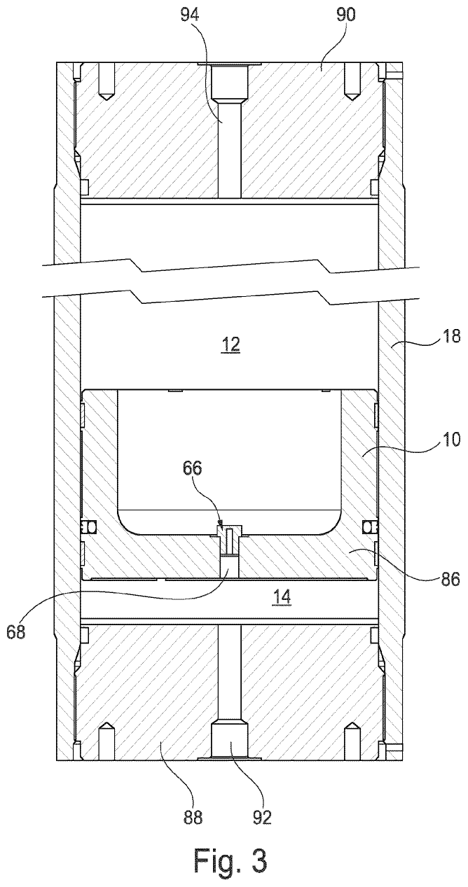

FIG. 3 shows a modified embodiment of the solution in the form of a piston accumulator in which the separating element 10 is formed by a separating piston 86. The present embodiment is only explained in as much as it differs substantially from the preceding embodiment, the same components accordingly being provided with the same reference numerals, and the explanations provided for the preceding embodiment also applying to the further embodiment designed as a piston accumulator. In the known design, the hydraulic accumulator according to FIG. 3 in the form of a piston accumulator comprises a hollow-cylindrical accumulator housing 18, which is sealed by a lid 88 on its bottom side and a lid 90 on its top side. The separating piston 86 is generally a skirt-type piston that can be displaced axially in the accumulator housing 18, said piston in turn separating a first media chamber 12 with the working gas from the second media chamber 14 with the hydraulic fluid. As such, the separating piston 86 thus separates an oil side from a gas side of the piston accumulator. The second media chamber 14 can be connected via an oil port 92 that is coaxial with respect to the longitudinal axis of the hydraulic accumulator to the hydraulic system (not shown) and a gas filling port 94 is also located in the lid 90 on the top side, coaxially with respect to the longitudinal axis, the first media chamber 12 with the working gas, such as nitrogen, being able to be furnished with a predefined precharge pressure by means of said gas filling port. Such a gas filling port 94 can be sealed in the conventional manner via a sealing device, which is not shown in any further detail. The through opening 68 is accommodated in the bottom of the skirt of the separating piston 86, the upper free end of said opening emerging in the first media chamber 12 with the working gas as viewed on FIG. 3.

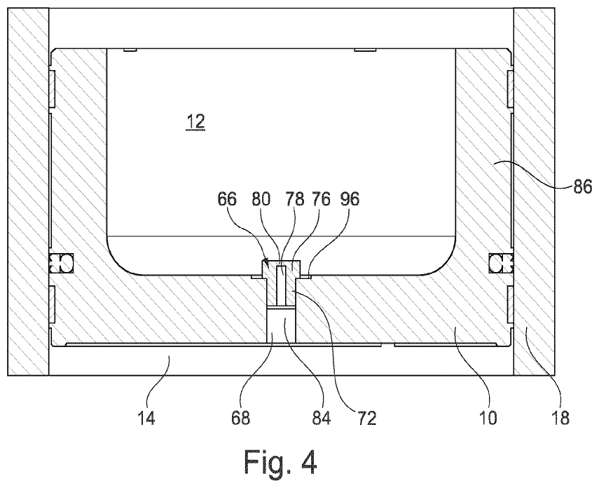

The bursting device 66 as shown in FIGS. 3 and 4 is constructed as for the bursting device 66 for FIGS. 1 and 2 described above, i.e. it has an engagement part 72 screwed into the through opening 68 of the separating element 10, said engagement part being furnished with a central longitudinal channel 78, which emerges at the bottom in the second media chamber 14 and is delimited at the top by the membrane 80 of the abutting part 76. This differs from the solution according to FIGS. 1 and 2 in that an annular central recess 96 is accommodated on the shallow bottom of the skirt, along which recess the abutting part 76 is supported on the separating piston 86 with an overhang. In this manner, once again, the working gas would be relieved in the direction of the liquid side in the event of failure after being released through the destroyed membrane 80.

The hydraulic accumulator solution has been explained in detail based on the design of a bellows or piston accumulator; however, it is also possible to accommodate the bursting device 66 in a membrane or bladder accumulator in the wall part of the elastomer membrane (not shown) in order to thus achieve burst protection even with this type of hydraulic accumulators.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A hydraulic accumulator comprising an accumulator housing and a separating element which is arranged therein in a longitudinally movable manner and which separates two media chambers within the accumulator housing, and with a bursting device for reducing an inadmissibly high pressure in the accumulator housing, wherein the bursting device is arranged in the separating element, and when the bursting device bursts, a media-conducting connection between the two media chambers is released via the separating element.

12. The Hydraulic accumulator of claim 11, wherein the bursting device is formed by a bursting plug, which is inserted into a through opening in the separating element.

13. The Hydraulic accumulator of claim 11, wherein the bursting device comprises an engagement part, which is inserted into the through opening.

14. The hydraulic accumulator of claim 11, wherein the bursting device comprises an abutting part, with a diameter that is larger than the diameter of the engagement part, and wherein the abutting part is in surface contact with the separating element.

15. The hydraulic accumulator of claim 11, wherein the engagement and abutting part are each integral components of the bursting device.

16. The hydraulic accumulator of claim 11, wherein at least one longitudinal channel runs in the engagement part, one end of the at least one channel emerging in the second media chamber with the liquid and the other end of the at least one channel emerging in the abutting part such that a kind of membrane arises on the top side of the abutting part, said membrane being adjacent to the first media chamber with the working gas.

17. The hydraulic accumulator of claim 11, wherein a sealing device is arranged between the bursting device and the separating element.

18. The hydraulic accumulator of claim 11, wherein the separating element is formed by the sealing body of a bellows of a bellows accumulator, the inside of which at least partially forms the first media chamber with the working gas.

19. The hydraulic accumulator of claim 11, wherein the separating element is formed by a separating piston of a piston accumulator.

20. The hydraulic accumulator of claim 11, wherein, in the event of the bursting device failing, all fragments of the bursting device remain sealed from the outside in the accumulator housing and wherein an associated inadmissibly high gas pressure is relieved on to the liquid side of the accumulator.

21. The hydraulic accumulator of claim 11, wherein a first of the media chambers is a chamber that is configured for a working gas and a second media chamber is configured for a liquid.

22. The hydraulic accumulator of claim 21, wherein the working gas is nitrogen gas.

23. The hydraulic accumulator of claim 21, wherein the liquid is a hydraulic oil.

24. The Hydraulic accumulator of claim 13, wherein the engagement part is screwed into the separating element via a threaded section along the through opening.

25. The Hydraulic accumulator of claim 11, wherein the bursting device comprises an engagement part, which is inserted into the through opening.

26. The hydraulic accumulator of claim 12, wherein the bursting device comprises an abutting part, with a diameter that is larger than the diameter of the engagement part, and wherein the abutting part is in surface contact with the separating element.

27. The hydraulic accumulator of claim 13, wherein the bursting device comprises an abutting part, with a diameter that is larger than the diameter of the engagement part, and wherein the abutting part is in surface contact with the separating element.

28. The hydraulic accumulator of claim 12, wherein the engagement and abutting part are each integral components of the bursting device.

29. The hydraulic accumulator of claim 13, wherein the engagement and abutting part are each integral components of the bursting device.

30. The hydraulic accumulator of claim 14, wherein the engagement and abutting part are each integral components of the bursting device.
